(19) United States
(12) Patent Application Publication
(10) Pub. No.: US 2004/0052489 A1
(43) Pub. Date: Mar. 18, 2004

(54) Optical structure for multi-photon excitation and the use thereof

(76) Inventors: Gert Ludwig Duveneck, Bad Krozingen (DE); Martin Andreas Bopp, Basel (CH); Michael Pawlak, Laufenburg (DE); Markus Ehrat, Magden (CH); Gerd Marowsky, Gottingen (DE)

Correspondence Address: WENDEROTH, LIND & PONACK, L.L.P., 2033 K STREET N. W., SUITE 800, WASHINGTON, DC, 20006-1021, US

(21) Appl. No.: 10/473,325

(22) PCT Filed: Mar. 18, 2002
(86) PCT No.: PCT/EP02/02958

(30) Foreign Application Priority Data
Apr. 2, 2001 (CH) 0617/01
Apr. 12, 2001 (CH) 0689/01

(51) Int. Cl. G02B 6/10

(52) U.S. Cl. 385/130

(57) ABSTRACT

The invention relates to a variable embodiment of an optical structure, comprising an optical waveguide with a waveguiding layer (a), being optically transparent at least at an excitation wavelength, wherein the intensity of an excitation light in-coupled into layer (a) and guided in layer (a) is high enough within layer (a) and on layer (a), that molecules located on the surface of layer (a) or within a distance of less than 200 nm, which are capable of luminescence and/or photo-reactive, can be excited by multi-photon excitation, preferably by two-photon excitation. Thereby, embodiments are preferred which allow for a multi-photon excitation along macroscopic distances or on extended surfaces, along the trace of the excitation light guided in layer (a). The invention is also related to different embodiments of optical systems and of analytical systems with an excitation light source and an embodiment of an optical structure according to the invention, as well as to methods based thereon, especially for luminescence excitation and for the determination of one or more analytes by luminescence detection after multi-photon excitation, and its use.

The present invention relates to a variable embodiment of an optical structure, comprising an optical waveguide with a waveguiding layer (a), being optically transparent at least at an excitation wavelength, wherein the intensity of an excitation light in-coupled into layer (a) and guided in layer (a) is high enough within layer (a) and on layer (a), that molecules located on the surface of layer (a) or within a distance of less than 200 nm, which are capable of luminescence and/or photo-reactive, can be excited by multi-photon excitation, preferably by two-photon excitation. Thereby, embodiments are preferred which allow for a multi-photon excitation along macroscopic distances or on extended surfaces, along the trace of the excitation light guided in layer (a). The present invention is also related to different embodiments of optical systems and of analytical systems with an excitation light source and an embodiment of an optical structure according to the invention, as well as to methods based thereon, especially for luminescence excitation and for the determination of one or more analytes by luminescence detection after multi-photon excitation, and its use.

The goal of this invention is to provide optical structures and easily usable optical methods for enabling multi-photon excitation of molecules, which are capable of luminescence and/or photo-reactive, in the near-field of the waveguide structure, i.e. on this structure or within a distance of less than about 200 nm.

Within the scope of this invention, under “multi-photon excitation” is understood, that a molecule (or a molecular group) absorbs multiple photons of an irradiated excitation wavelength, before it relaxes from the resulting excited state to another state, especially to the ground state. The result of such a multi-photon excitation can be a luminescence, especially fluorescence, emitted upon the decay to the ground state, with a shorter wavelength than the irradiated excitation wavelength. The result can also be the overcoming of the activation barrier for the transition into a photo-reactive state. This photo-reactive state can lead to the formation of molecular bonds to other molecules or molecular complexes (e.g. in form of a photopolymerization), or also to the breakage of existing bonds (photodissociation, which may be followed by desorption). Correspondingly, under “one-photon excitation” is understood, that a molecule is excited into said excited state by the absorption of a single photon.

If not explicitely marked different, the term “molecular group” (such as a fluorescence label as part of a fluorescently marked molecule) is included in the use of the term “molecule”.

For example in biochemical analytics, there is a large need for arrangements and methods for the determination of an analyte in a supplied sample with high selectivity and sensitivity, by using biochemical or biological or synthetic recognition elements immobilized on a surface. Thereby, many known determination methods are based on the detection of one or more luminescences in presence of the analyte.

Thereby in this application, the term “luminescence” shall mean the spontaneous emission of photons in the ultra-violet to infra-red spectral range, after optical or non-optical, such as electrical, chemical, biochemical or thermal, excitation. For example, chemiluminescence, bioluminescence, electroluminescence and especially fluorescence and phosphorescence are included in the term “luminescence”.

In the following, the term “optical transparency of a material” is used in the sense that transparency of the material is required at at least an excitation wavelength. At a shorter or longer wavelength, this material can also be absorbent.

Sensitivity has been enhanced significantly in the last years by means of highly refractive thin-film waveguides, based on only a few hundred nanometers of thin waveguiding film. For example, in WO 95/33197, a method is described wherein the excitation light is coupled into the waveguiding film using a relief grating as a diffractive optical element. The surface of the sensor platform is brought into contact with a sample containing the analyte, and the isotropically emitted luminescence from substances capable of luminescence and located within the penetration depth of the evanescent field is recorded by adequate measurement devices, such as photodiodes, photomultipliers or CCD-cameras. It is also possible to couple out, by a diffractive optical element such as a grating, and measure the fraction of evanescently excited luminescence, that has been coupled back into the waveguide. This method has been described, for example, in WO 95/33198.

In the following, the terms “evanescent field” and “near-field” are used synonymously.

It is a disadvantage of methods for the detection of evanescently excited luminescence described above in the state-of-the-art, especially in WO 95/33197 and WO 33/198, that always only one sample can be analyzed on the waveguiding layer, provided as a homogeneous film, of the sensor platform. In order to enable further measurements on the same sensor platform, tedious washing and cleaning steps are continuously required. This applies, especially, if another analyte than that in the first measurement shall be determined. Ina case of an immunoassay, this typically means that the whole immobilized layer on the sensor platform has to be exchanged, or that a new sensor platform as a whole has to be used.

Therefore, there is also a need for the development of a method allowing analysis of several samples in parallel, i.e., simultaneously or immediately one after the other, without additional cleaning steps.

For the simultaneous or sequential performance of multiple measurements exclusively based on luminescence detection, using essentially monomodal, planar inorganic waveguides, for example, in WO 96/35940, devices (arrays) have been reported, wherein at least two discrete waveguiding regions are arranged on one sensor platform, which are irradiated separate from one another with excitation light. As a disadvantageous consequence of the segregation of the sensor platform into separate waveguiding areas, however, the area requirements for discrete measurement areas in discrete waveguiding regions on the common sensor platform are relatively large. Therefore, again, only a relatively small density of different measurement fields (or so-called “features”) can be achieved.

Therefore, there is also a need for an increase of the feature density or for a decrease of the required area per measurement area, respectively.

Based on simple glass or microscope slides, without additional waveguiding layers, arrays with a very high feature density are known. For example, in U.S. Pat. No. 5,445,934 (Affymax Technologies), arrays of oligonucleotides with a density of more than 1000 features on a square centimeter are described and claimed. The excitation and read-out of such arrays are based on classical optical arrangements and methods. The whole array can be illuminated simultaneously, using an expanded excitation light bundle, which, however, results in a relatively low sensitivity. The portion of scattered light is relatively large and scattered light or background fluorescence light from the glass substrate is also generated in those regions, where no oligonucleotides for binding of the analyte are immobilized. In order to limit excitation and detection to the regions of immobilized features and to suppress light generation in the adjacent regions, there is widespread use of confocal measurement arrangements, and the different features are analyzed sequentially by scanning. The consequences, however, are an increased amount of time for the read-out of a large array and a relatively complex optical set-up.

Therefore, there is a need for an embodiment of the sensor platform and for an optical arrangement that achieve a sensitivity as high as has been achieved with sensor platforms based on thin-film waveguides and for simultaneously minimizing the required measurement area per feature.

In a co-pendent application (PCT/EP 00/04869), a sensor platform with a film waveguide, comprising an optically transparent layer (a) on a second layer (b) with lower refractive index than layer (a) and a grating structure (c) modulated in layer (a), with measurement areas provided thereon, is described. Thereby, the luminescence light back-coupled into layer (a), after in-coupling excitation light to the measurement areas and associated luminescence excitation in the near-field of layer (a), can be out-coupled completely over short distances, i.e., some hundred micrometers, upon the adequate choice of the parameters, especially of the grating depth, and thus be prevented from further spreading in the waveguiding layer (a).

This arrangement allows for a highly sensitive, simultaneous determination of a multitude of analytes on a very small area. Upon optimization of the paths of rays and masking against reflections or scattered light, the sensitivity can be further increased. Finally, however, the background signals and the associated noise of the background remain limiting. Besides other reasons, this is caused by the fact that, for most applied luminescence dyes, the spectral separation between excitation end emission wavelength (Stokes shift) is relatively small, typically between 20 nm and 50 nm. Although some luminescence dyes exhibiting a large Stokes shift, up to 300 nm, are known, these dyes generally have, as a disadvantage, a relatively small quantum yield and/or photo stability.

Additionally, it is a disadvantage of the known arrangements based on highly refractive thin-film waveguides, for example, based on waveguiding films of Ta₂O₅ or TiO₂, combined with conventional excitation, that the propagation losses of these waveguides, as well as the autofluorescence of these thin-film waveguides (for example, caused by traces of fluorescent contaminations in layer (b)) increase drastically at short excitation wavelengths. Consequently, short-wavelength excitation is limited to about 450 nm to 500 nm. However, an arrangement would be appreciated which would allow for exciting fluorophores also at shorter wavelengths and for detecting their luminescences with a background as low as possible or even without the background, at best.

Recently methods have been reported which allow for almost background-free luminescence detection and are based on two-photon excitation. However, a two-photon excitation requires extremely high field strengths and respectively intensities of the excitation light. In the described arrangements, this is achieved with powerful pulsed lasers with extremely short pulse durations (typically femto seconds). However, these optical arrangements are characterized by very high system costs, and they impose high requirements on the specific qualification of the users. In a very early work in U.S. Pat. No. 3,572,941 from 1967, concerning the development of arrangements for reproduction and storage of three-dimensional images, it is described that, for example, for the (permanent) change of the optical density of a storage medium, such as a single-crystal, e.g., CaF₂ doted with La, excitation intensity densities of the the order of 20•MW/cm² are required. Such high intensity densities have, for example, been achieved and described using pulsed high-power lasers in confocal microscopic arrangements, for example, in U.S. Pat. No. 5,034,613, with a diameter of the laser focus below one micrometer in the focal plane of the microscope. The measurement of an extended area by scanning, however, requires a large investment in time, besides the high instrumental effort.

It has now been found surprisingly, that, upon the adequate choice of the physical parameters of an optical structure based on a thin-film waveguide, with a waveguiding layer (a), transparent at least at an excitation wavelength, on a layer (b) with lower refractive index than layer (a), which is also transparent at said excitation wavelength, and upon application of sufficiently high excitation light intensities, the intensity of an excitation light in-coupled into layer (a) and guided in layer (a) is high enough on layer (a) and within layer (a), that molecules located on the surface of layer (a) or within a distance of less than 200 nm from layer (a) are excited to luminescence by multi-photon absorption.

With a preferred embodiment of an optical structure according to the invention, provided as a planar thin-film waveguide with a layer (a), transparent at least at an excitation wavelength, on a layer (b) with lower refractive index than layer (a), also transparent at least at said excitation wavelength, and with at least one grating structure (c) modulated in layer (a), it could surprisingly be shown that the intensity of an excitation light launched at the resonance angle for in-coupling into layer (a) is high enough on layer (a) and within layer (a) even along the whole path of propagation of the excitation light in layer (a), that molecules capable of luminescence, that are immobilized on layer (a), can be excited by two-photon excitation along a linear trace and even on extended surfaces along said path of propagation. Thereby, a luminescence such strong can be generated by two-photon absorption, that it can even be observed at ambient light by naked eye.

Whereas so far, a multi-photon excitation was only possible on smallest space, i.e., in the focus of high-power lasers (typically femto-second lasers pulsed at a high repetition rate), the present invention enables a simultaneous two-photon luminescence excitation and observation in macroscopic dimensions, i.e., along extensions of millimeters to centimeters and on areas of square millimeters to square centimeters. Thanks to the present invention, the requirements on the pulse energies of the excitation light sources, for a single pulse, can considerably be reduced, which means, that use of lasers with longer pulses (e.g., of pico-second or even nano-second lasers instead of femto-second lasers) or even of continuously emitting (cw) lasers for multi-photon luminescence excitation with a waveguide structure according to the invention becomes possible.

An important advantage of a luminescence excitation by multi-photon excitation in the evanescent field of a waveguide, especially for an analyte dertermination using surface-bound recognition elements for the analyte, is a further significantly increased selectivity of the excitation with respect to increasing distance from the highly refractive waveguide surface, in comparison with the classical excitation by one-photon absorption. Wheras the strength of the evanescent field and the intensity of a luminescence (proportional to the field strength) generated by classical one-photon absorption decreases exponentially with the distance x, the decrease of luminescence after n-photon absorption is proportional to 1/e^{nx}, i.e. for the case of two-photon excitation proportional to 1/e^{2x}.

Due to the very high, surface-bound excitation light intensities, that can be achieved with relatively little effort, even for relatively low irradiated excitation intensities because of the very high amplification factors, optical structures according to the invention can be applied in a variety of different technical fields, also outside of bioanalytics, for example for the investigation of photophysical or photochemical properties of especially new materials exposed to high excitation light intensities.

In particular, photo-reactive molecules or molecular groups located within the very small distance (z-direction) from the waveguide structure can be excited to chemical reactions by multi-photon excitation, preferably by two-photon excitation, as will be described in more detail below, concerning the different embodiments of the invention. These chemical reactions can be the formation of chemical bonds to adjacent molecules, for example resulting in a photopolymerization capable to generate three-dimensional structures of molecular extensions in z-direction in a simple manner. The chemical reactions can also be the surface-confined selective breakage of molecular bonds, on a macroscopic basic area, resulting, for example, in new, simplified methods for mass spectrometry, especially for MALDI/TOF-MS (matrix-assisted laser desorption/ionization time-of-flight mass spectrometry), and for molecular separations, as a new, optical chromatographic method.

A first subject of the invention is an optical structure comprising an optical waveguide with a waveguiding layer (a), optically transparent at least at an excitation wavelength, wherein the intensity of an excitation light in-coupled into layer (a) and guided in layer (a) is high enough within layer (a) and on layer (a), that molecules located on the surface of layer (a) or within a distance of less than 200 nm can be excited by multi-photon excitation.

Preferably, said optical waveguide is an optical thin-film waveguide with a waveguiding layer (a), optically transparent at least at one excitation wavelength, on a layer (b) with lower refractive index than layer (a), which is also optically transparent at least at the excitation wavelength.

Characteristic for one group of embodiments of the optical structure according to the invention is that the molecules located on the surface of layer (a) or within a distance of less than 200 nm and excited by multi-photon excitation are photo-reactive molecules or molecular groups, i.e., which are chemically reactive after excitation by light. These photo-reactive molecules can, for example, be so-called photo-initiators, which can initiate a photo-polymerization after irradiation of an adequate, typically short-wavelength, excitation light (e.g., UV light). Thus, characteristic for this special embodiment is, that a photopolymerization is initiated by the multi-photon excitation of said photo-reactive molecules located on layer (a) or within a distance of less than 200 nm. This leads to a two-fold advantage in comparison with the state-of-the-art. First, a polymerization can be excited efficiently close to the surface (defined by the distance z from the waveguiding layer (a) of the structure, within which distance a two-photon excitation of the compound under consideration is possible), upon irradiation of relatively low excitation intensities. On the other side, extremely shallow (i.e. of molecular size) three-dimensional structures (i.e. of molecular size), defined by the distance z, can be created in an easy way. Thereby, the linear or lateral extension, in parallel to the surface of the optical structure, is limited by the propagation length of the irradiated excitation light within the waveguiding layer (a). If the process of photo-polymerization is performed on a grating structure modulated in layer (a), for the simultaneous in-coupling and out-coupling of the excitation light (see more detailed description below), polymer structures of also very small lateral extensions (of the order of micrometers) can be generated or “written” (by lateral movement of the optical structure with respect to the irradiated excitation light).

Characteristic for another embodiment of an optical structure according to the invention is that a photo-dissociation, i.e., the breakage of a molecule or of molecular complexes provided on layer (a) or within a distance of less than 200 nm from layer (a) and existing until the moment of multi-photon excitation, is initiated by multi-photon excitation of said photo-reactive molecules on layer (a) or within a distance of less than 200 nm from layer (a).

Characteristic for a special variant is that said photo-reactive molecules are part of a molecular matrix for embedding molecules of higher molecular weight, especially natural and artificial (synthetic) polymers respectively biological molecules, such as proteins, polypeptides, and nucleic acids. Thereby, it is especially preferred that the optical structure is provided as a sample carrier for mass spectrometry, preferably for MALDI/TOF-MS (matrix-assisted laser desorption/ionization time-of-flight mass spectrometry).

Another preferred embodiment is an optical structure comprising an optical thin-film waveguide with a waveguiding layer (a), optically transparent at least at an excitation wavelength, on a layer (b) of lower refractive index than layer (a), also optically transparent at least at said excitation wavelength, wherein the intensity of an excitation light in-coupled into layer (a) and guided in layer (a) is high enough on layer (a) and within layer (a), that molecules located on the surface of layer (a) or within a distance of less than 200 nm from layer (a) are excited to luminescence by multi-photon excitation.

The in-coupling of excitation light into layer (a) can be performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

Preferably, the in-coupling of the excitation light into layer (a) is performed by means of a grating structure modulated in layer (a).

Additionally, it is preferred that the optical structure is a planar thin-film waveguide structure.

Especially preferred is an embodiment of the optical structure according to the invention comprising a planar thin-film waveguide with a layer (a), optically transparent at least at an excitation wavelength, on a layer (b) with lower refractive index than layer (a), also optically transparent at least at said excitation wavelength, and with at least one grating structure (c) modulated in layer (a), wherein the intensity of an excitation light launched at the resonance angle for in-coupling into layer (a) is sufficiently high on layer (a) and within layer (a) at least in the region of the grating structure (c), that molecules located on the surface of layer (a) or within a distance of less than 200 nm from layer (a) are excited by multi-photon excitation.

Preferably, the multi-photon excitation is a two-photon excitation.

By means of an optical structure according to the invention it is possible to excite molecules located on the surface of layer (a) or within a distance of less than 200 nm from layer (a) by multi-photon excitation along a linear path, i.e., simultaneously along the excitation light guided in layer (a).

Especially advantageous are such embodiments which enable multi-photon excitation of molecules located on the surface of layer (a) or within a distance of less than 200 nm from layer (a) along a linear path along a distance of at least 5 mm, starting from the position of the incoupling of the excitation light into layer (a).

It is also of special advantage if molecules located on the surface of layer (a) or within a distance of less than 200 nm from layer (a) are excited by multi-photon excitation simultaneously on extended areas along the excitation light guided in layer (a), upon irradiation of an expanded excitation light. In case of in-coupling of light into layer (a) by means of a grating (c), the excitation light bundle is preferably expanded in parallel to the grating lines.

It is preferred, that an optical structure according to the invention is operable for simultaneous multi-photon excitation of molecules located on the surface of layer (a) or within a distance of less than 200 nm from layer (a) on an area of at least 1 mm², more preferred on an area of at least 10 mm², still more preferred on an area of at least 1 cm².

The very high, surface-confined excitation light intensity, respectively high intensity close to the surface, especially for enabling a multi-photon excitation, is advantageous for a variety of applications, especially for biosensing, as will be outlined in more detail below, but also in communications and telecommunication techniques.

Furtheron, it is preferred that the structure comprises continuous, unmodulated regions of layer (a), which are preferably arranged in direction of propagation of an excitation light in-coupled by a grating structure (c) and guided in layer (a). Especially, the structure can be designed in such a way that a multitude of grating structures (c) with identical or different period, optionally adjacent thereto with continuous, unmodulated regions of layer (a), is provided on a common, continuous substrate. Thus, in case of luminescence excitation by multi-photon excitation, it is also possible that a luminescence generated on or in the near-field of layer (a) by multi-photon absorption, is coupled at least partially into layer (a) and is propagated to adjacent regions on said optical structure by guiding in layer (a).

For certain applications it is desirable to apply excitation light of different excitation wavelengths to the same optical structure simultaneously or sequentially. Then it can be advantageous, if this structure comprises a superposition of two or more grating structures of different periodicity, with grating lines arranged in parallel or non-parallel, preferably nonparallel, which structure is operable for the in-coupling of excitation light of different wavelengths, wherein in case of two superimposed grating structures, their grating lines are preferably arranged perpendicular to each other.

The amount of the propagation losses of a mode guided in an optically waveguiding layer (a) is determined to a large extent by the surface roughness of a support layer located below, as well as by the absorption of chromophores that might occur in that carrier layer, which is additionally associated with the risk of excitation of luminescence in that carrier, which is undesired for many applications, due to the penetration of the evanescent field of the mode guided in layer (a). Additionally, thermal strain due to different coefficients of thermal expansion of the optically transparent layers (a) and (b) can occur. In a case of a chemically sensitive optically transparent layer (b), in a case where it consists of, for example, a transparent thermoplastic plastic, it is desirable to prevent the penetration of solvents that might attack layer (b) through micropores that might exist in the optically transparent layer (a).

In case of a waveguide comprising multiple layers ((a) and (b)), it is therefore of advantage, if a further optically transparent layer (b′) with lower refractive index than the one of layer (a) and with a thickness of 5 nm-10 000 nm, preferably of 10 nm-1000 nm, is located between layers (a) and (b) and in contact with layer (a). Upon introduction of this intermediate layer, a variety of tasks can be fulfilled: reduction of surface roughness below layer (a), reduction of the penetration of the evanescent field of light guided in layer (a) into the one or more layers located below, reduction of thermally induced stress within the grating waveguide structure, and chemical isolation of the optically transparent layer (a) from layers located below by the sealing of micropores in layer (a) against the layers located below.

The grating structure (c) of the optical structure according to the invention can be a diffractive grating with a uniform period or a multidiffractive grating. The grating structure (c) can also be provided with a laterally varying periodicity, perpendicular or parallel to the direction of propagation of the excitation light coupled into the optically transparent layer (a).

There are a lot of different materials that can be used for the optically transparent layer (a). Most important prerequisites are the absence of absorption or luminescence, at least at the wavelength of the launched excitation light, in an extent as large as possible, and the ability for light-guiding at least over distances of the order of millimeters to centimeters.

For certain embodiments of an optical structure according to the invention it is preferred, that the material of the optically transparent layer (a) comprises glass, quartz or a transparent plastic, for example, from the group comprising polycarbonate, polyamide, polyimide, poly methylmethacrylate, polypropylene, polystyrene, polyethylene, polyacrylic acid, polyacrylic ester, polyphenylenesulfide, polyethyleneterephtalate (PET) and polyurethane and their derivatives.

The optically transparent layer (a) can also comprise a material of the group of TiO₂, ZnO, Nb₂O₅, Ta₂O₅, HfO₂, or ZrO₂, especially preferred of TiO₂ or Nb₂O₅ or Ta₂O₅.

It is also preferred that the refractive index of the optically transparent layer (a) is larger than 1.8.

The optically transparent layer (a) can be provided in a variety of “externally” different embodiments. It can be a fiber-type or a planar waveguide. Still further, technically manufacturable geometries are possible.

The optically transparent layer (a) can be self-supporting, for example, with a thickness (or diameter in case of fiber-type waveguides) of the order of micrometers to millimeters. Layer (a) can also be part of a multi-layer system, with layers of lower refractive index (than the one of layer (a)) adjacent to layer (a), wherein again both fiber-type and planar embodiments are possible.

It is of special advantage, if the optically transparent layer (a) is a low-modal waveguide, i.e., it is operable to guide less than the first 10 modes of a given polarization of an irradiated excitation light.

It is specially preferred, that the optically transparent layer (a) is a low-modal waveguide, which is operable to guide only 1-3 modes of a given polarization of an irradiated excitation light.

As already outlined above, embodiments of an optical structure according to the invention as a (planar) optical thin-film waveguide are specially preferred.

Then, it is further preferred that the material of the optically transparent layer (b) comprises glass, quartz or a transparent thermoplastic or moldable plastics, for example from the group formed by polycarbonate, polyimide, poly methylmethacrylate, polypropylene, polystyrene, polyethylene, polyacrylic acid, polyacrylic ester, polyphenylenesulfide, polyethyleneterephtalate (PET) and polyurethane.

Besides the refractive index of the waveguiding optically transparent layer (a), its thickness is the second important parameter for the generation of an evanescent field as strong as possible at the interfaces to adjacent layers with lower refractive indexes, and for generation of an energy density as high as possible within layer (a). With a decreasing thickness of the waveguiding layer (a), the strength of the evanescent field increases as long as the layer thickness is sufficient for guiding at least one mode of the excitation wavelength. Thereby, the minimum “cut-off” layer thickness for guiding a mode is dependent on the wavelength of this mode. The “cut-off” layer thickness is larger for light of a longer wavelength than for light of a shorter wavelength. Approaching the “cut-off” layer thickness, however, also unwanted propagation losses (in especial due to scattering at scattering centers) increase strongly, thus additionally setting a lower limit for the choice of the preferred layer thickness. However, these propagation losses are generally lower for longer-wavelength light than for short-wavelength light. Preferred are layer thicknesses of the optically transparent layer (a) allowing for guiding only one to three modes at a given excitation wavelength. Especially preferred are layer thicknesses resulting in monomodal waveguides for this given excitation wavelength. It is understood that the character of discrete modes of the guided light does only refer to the transversal modes.

Resulting from these requirements, the product of the thickness of layer (a) and of its refractive index is preferably between one tenth and a whole, most preferably between one tenth and two thirds of the excitation wavelength of the excitation light to be coupled into layer (a).

For given refractive indices of the waveguiding, optically transparent layer (a) and of the adjacent layers, the resonance angle for in-coupling of the excitation light, according to the above mentioned resonance condition, is dependent on the diffraction order to be in-coupled, on the excitation wavelength and on the grating period. In-coupling of the first diffraction order is advantageous for increasing the in-coupling efficiency. Besides the number of the diffraction order, the grating depth is important for the amount of the in-coupling efficiency. As a matter of principle, the coupling efficiency increases with increasing grating depth. The process of out-coupling being completely reciprocal to the in-coupling, however, the out-coupling efficiency increases simultaneously, resulting in an optimum for the excitation of luminescence in a measurement area (d) (according to the definition below) located on or adjacent to the grating structure (c), the optimum being dependent on the geometry of the measurement areas and of the launched excitation light bundle. Based on these boundary conditions, it is advantageous if the grating (c) has a period of 200 nm-1000 nm and a modulation depth of 3 nm-100 nm, preferably of 10 nm-30 nm.

Furtheron, it is preferred that the ratio of the modulation depth of the grating to the thickness of the first optically transparent layer (a) is equal or smaller than 0.2.

Thereby, the grating structure (c) can be a relief grating with a rectangular, triangular or semicircular profile or a phase or volume grating with a periodic modulation of the refractive index in the essentially planar, optically transparent layer (a).

Furtheron, it can be advantageous if optically or mechanically recognizable marks for simplifying adjustments in an optical system and/or for the connection to sample compartments as part of an analytical system are provided on the structure.

The optical structure according to the invention is especially suited for application in biochemical analytics for the highly sensitive detection of one or more analytes in one or more supplied samples. For these applications, biological, biochemical or synthetic recognition elements, for recognition and binding of analytes to be determined, are immobilized on the optical structure. The immobilization can be performed on large surfaces, possibly over the whole structure, or in discrete so-called measurement areas.

In the spirit if this invention, laterally separated measurement areas (d) shall be defined by the area that is occupied by biological, biochemical or synthetic recognition elements immobilized thereon for recognition of one or multiple analytes in a liquid sample. These areas can have any geometry, for example the form of dots, circles, rectangles, triangles, ellipses or lines. It is possible that up to 1,000,000 measurement areas are provided in a two-dimensional arrangement on an optical structure according to the invention, wherein a single measurement area can occupy, for example, an area of 0.001 mm²-6 mm². Within a given measurement area, identical recognition elements for recognition and binding, respectively, determination of a single analyte, or also different recognition elements, for recognition of different analytes, can be immobilized. As recognition elements, such compounds can also be applied which are provided with several (i.e. two or more) different regions or segments to which different analytes can be bound.

For example, in a case of a planar thin-film waveguide with one or more grating structures (c) for the in-coupling of excitation light as the waveguide structure, the measurement areas can be arranged on such a grating structure or on a continuous, unmodulated region located after such a grating structure, with respect to the direction of propagation of the guided excitation light.

In order to determine multiple analytes in a sample simultaneously, it can be advantageous if two or more laterally separated measurement areas are combined to segments on the optical structure. Different segments can be separated from one another, especially optically, if a crosstalk of luminescence generated in adjacent segments and back-coupled into layer (a) shall be prevented by grating structures (c) or by other separations generated on the optical structure, such as absorbing strips of a deposited pigment or by the separating walls of structures for generation of sample compartments having the waveguiding layer (a) of the optical structure as the bottom surface. Different segments can additionally be separated from each other by a deposited rim supporting the fluidic sealing between adjacent areas and/or contributing to a reduction of the optical cross-talk between adjacent areas.

There are many methods for the deposition of the biological, biochemical or synthetic recognition elements on the optically transparent layer (a). For example, the deposition can be performed by physical adsorption or electrostatic interaction. In general, the orientation of the recognition elements is then of statistic nature. Additionally, there is the risk of washing away a part of the immobilized recognition elements, if the sample containing the analyte and reagents applied in the analysis process have a different composition. Therefore, it can be advantageous if an adhesion-promoting layer (f) is deposited on the optically transparent layer (a) for immobilization of biological, biochemical or synthetic recognition elements (e). This adhesion-promoting layer should be transparent as well. Especially, the thickness of the adhesion-promoting layer should not exceed the penetration depth of the evanescent field out of the waveguiding layer (a) into the medium located above. Therefore, the adhesion-promoting layer (a) should have a thickness of less than 200 nm, and preferably of less than 20 nm. The adhesion-promoting layer can comprise, for example, chemical compounds of the group comprising silanes, epoxides, functionalized, charged or polar polymers, and “self-organized functionalized monolayers”.

As stated in the definition of the measurement areas, laterally separated measurement areas (d) can be generated by laterally selective deposition of biological or biochemical or synthetic recognition elements on the optical structure. When brought into contact with an analyte capable of luminescence, a luminescently marked analogue of the analyte competing with the analyte for the binding to the immobilized recognition elements, or a further luminescently marked binding partner in a multi-step assay, these molecules capable of luminescence will bind to the surface of the optical structure selectively only in the measurement areas, which are defined by the areas occupied by the immobilized recognition elements.

For the deposition of the biological, biochemical or synthetic recognition elements, one or more methods of the group of methods comprising ink jet spotting, mechanical spotting, micro contact printing, and fluidic contacting of the measurement areas with the biological, biochemical or synthetic recognition elements upon their supply in parallel or crossed micro channels, upon application of pressure differences or electric or electromagnetic potentials, can be applied.

Without limitation of generality, components of the group comprising, for example, nucleic acids (e.g. DNA, RNA, oligonucleotides), nucleic acid analogues (e.g. PNA), antibodies, aptamers, membrane-bound and isolated receptors, their ligands, antigens for antibodies, “histidin-tag components”, cavities generated by chemical synthesis, for hosting molecular imprints. etc., can be deposited as biological, biochemical or synthetic recognition elements. With the last-named type of recognition elements are meant cavities that are produced by a method described in the literature as “molecular imprinting”. In this procedure, the analyte or an analyte-analogue, mostly in organic solution, is encapsulated in a polymeric structure. Then it is called an “imprint”. Then, the analyte or its analogue is dissolved from the polymeric structure upon addition of adequate reagents, leaving an empty cavity in the polymeric structure. This empty cavity can then be used as a bindung site with high steric selectivity in a later method of analyte determination.

Of course, also any other compound which selectively recognizes an analyte to be determined and interacts with it, according to the desired and required selectivity for the application under consideration, is suited as a recognition element.

Also, whole cells or cell fragments can be deposited as biological or biochemical or synthetic recognition elements.

Said recognition elements can be deposited directly on the optical structure or by means of an adhesion-promoting layer on the optical structure.

Additionally, the functions of “recognition element” and “analyte” are exchangeable in such a sense, that, if necessary after an adequate chemical preparation, the compounds contained in a sample to be analyzed can be immobilized on an optical structure according to the invention, and the corresponding biological, biochemical or synthetic recognition elements are brought into contact with them in a consecutive step. Thereby, discrete measurement areas can, for example, be generated, after partition of a sample into discrete aliquots, upon the consecutive deposition of these aliquots on discrete areas on the optical structure. In this case, a mixture of different compounds would typically be immobilized in each measurement area.

In many cases, the detection limit of an analytical method is limited by signals caused by so-called nonspecific binding, i.e., by signals caused by the binding of the analyte or of other components applied for analyte determination, which are not only bound in the area of the provided immobilized biological or biochemical or synthetic recognition elements, but also in areas of a sensor platform that are not occupied by these recognition elements, for example, upon hydrophobic adsorption or electrostatic interactions. Therefore, it is advantageous if compounds that are “chemically neutral” towards the analyte are deposited between the laterally separated measurement areas (d) in order to minimize nonspecific binding or adsorption. Such compounds are called “chemically neutral” compounds which themselves do not have specific binding sites for the recognition and binding of the analyte, an analogue of the analyte, or a further binding partner in a multistep assay, and which prevent, due to their presence, the access of the analyte, its analogue, or the further binding partners to the surface of the sensor platform.

Compounds of the groups formed by albumins, especially bovine serum albumin or human serum albumin, fragmented natural or synthetic DNA not hybridizing with polynucleotides to be analyzed, such as herring or salmon sperm, or also uncharged but hydrophilic polymers, such as poly ethyleneglycols or dextranes, can, for example, be applied as “chemically neutral” compounds.

Especially, the selection of the mentioned compounds for a reduction of nonspecific hybridization in polynucleotide hybridization assays (such as herring or salmon sperm) is thereby determined by the empirical preference for DNA as different as possible from the polynucleotides to be analyzed, about which no interaction with the polynucleotide sequences to be analyzed is known.

A further subject of the invention is an optical system comprising at least one excitation light source and an optical structure according to the invention, wherein the intensity of an excitation light in-coupled into layer (a) and guided in layer (a) is high enough within layer (a) and on layer (a), that molecules located on the surface of layer (a) or within a distance of less than 200 nm can be excited by multi-photon excitation.

Characteristic for one group of embodiments of an optical system according to the invention is that the molecules excited by multi-photon excitation on the surface of layer (a) or within a distance of less than 200 nm from layer (a) are photo-reactive molecules, i.e., molecules or molecular groups which are chemically reactive after excitation by light. Thereby, as one variant, a photo-polymerization is initiated by the multi-photon excitation of said photo-reactive molecules located on the surface of layer (a) or within a distance of less than 200 nm from layer (a). Then, for example, compounds with photo-labile protective groups are suited as photoreactive molecules.

Characteristic for another variant is that a photo-dissociation, i.e., the breakage of a molecule or molecular complex existing before the step of multi-photon excitation on layer (a) or within a distance of less than 200 nm from layer (a), is caused by the multi-photon excitation of said photo-reactive molecules located on layer (a) or within a distance of less than 200 nm from layer (a).

As a special variant, said photo-reactive molecules are part of a molecular matrix for embedding molecules of higher molecular weight, especially natural and artificial (synthetic) polymers, respectively, biological molecules, such as proteins, polypeptides and nucleic acids. Especially preferred is such an embodiment wherein the optical structure is provided as a sample carrier for mass spectrometry, preferably for MALDI/TOF-MS (matrix-assisted laser desorption/ionization time-of-flight mass spectrometry).

Preferred is an optical system for multi-photon excitation comprising at least one excitation light source and an optical structure according to the invention, wherein the intensity of an excitation light in-coupled into layer (a) and guided in layer (a) is high enough within layer (a) and on layer (a) that molecules located on the surface of layer (a) or within a distance of less than 200 nm can be excited to luminescence by multi-photon excitation.

The optical system according to the invention is typically designed in such a way that in-coupling of excitation light into layer (a) is performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

It is preferred, that in-coupling of the excitation light into layer (a) is performed by means of a grating structure modulated in layer (a).

It is also preferred, that the optical structure is a planar thin-film waveguide structure.

Especially preferred is an embodiment of an optical system according to the invention comprising at least one excitation light source and an optical structure according to any of embodiments described above, wherein the intensity of an excitation light launched at the resonance angle for in-coupling into layer (a) onto a grating structure (c) modulated in layer (a) is sufficiently high on layer (a) and within layer (a) at least in the region of the grating structure (c), that molecules located on the surface of layer (a) or within a distance of less than 200 nm from layer (a) are excited by multi-photon excitation.

Preferably, the multi-photon excitation is a two-photon excitation.

Preferred are such embodiments, which are operable to excite molecules located on the surface of layer (a) or within a distance of less than 200 nm from layer (a) by multi-photon excitation along a linear path, i.e., simultaneously along the excitation light guided in layer (a).

Especially advantageous are embodiments, which are operable for multi-photon excitation of molecules located on the surface of layer (a) or within a distance of less than 200 nm from layer (a) along a linear path along a distance of at least 5 mm, starting from the position of the in-coupling of the excitation light into layer (a).

It is also preferred that molecules located on the surface of layer (a) or within a distance of less than 200 nm from layer (a) are excited by multi-photon excitation simultaneously on extended areas along the excitation light guided in layer (a), upon irradiation of an expanded excitation light. If in-coupling of light into layer (a) is performed by means of a grating structure (c) modulated in layer (a), it is preferred that the excitation light bundle is expanded in parallel to the grating lines.

Of special advantage are also such embodiments of an optical system according to the invention, which enable simultaneous multi-photon excitation of molecules located on the surface of layer (a) or within a distance of less than 200 nm from layer (a) on an area of at least 1 mm², preferably on an area of at least 10 mm², still more preferred on an area of at least 1 cm².

Characteristic for other preferred embodiments of an optical system according to the invention is that the optical structure, as a part of the system, comprises continuous, unmodulated regions of layer (a), which are preferably arranged in direction of propagation of an excitation light in-coupled by a grating structure (c) and guided in layer (a). Again, it is also advantageous for many applications if the optical structure comprises a multitude of grating structures (c) with identical or different periods, optionally adjacent thereto with continuous, unmodulated regions of layer (a) on a common, continuous substrate.

An essential characteristics of many embodiments of an optical system for luminescence excitation, according to the invention, is also that a luminescence generated on or in the near-field of layer (a) by multi-photon absorption is coupled at least partially into layer (a) and is propagated to adjacent regions on said optical structure by guiding in layer (a).

Typically, an optical system according to the invention additionally comprises at least one detector for the detection of one or more luminescences from the optical structure.

There are a variety of different possible embodiments for the geometry of ray guiding of the excitation light until hitting the optical structure. Characteristic for one of the preferred embodiments is that the excitation light emitted from the at least one excitation light source is essentially parallel and irradiated on a grating structure (c) modulated in the optically transparent layer (a) at the resonance angle for in-coupling into layer (a).

It is especially preferred, that the excitation light from at least one light source is expanded to an essentially parallel ray bundle by expansion optics and irradiated on a grating structure (c) of macroscopic area modulated in the optically transparent layer (a) at the resonance angle for incoupling into layer (a).

Characteristic for another preferred embodiment is that the excitation light from the at least one light source is divided into a plurality of individual rays of as uniform as possible intensity by a diffractive optical element, or in a case of multiple light sources, by multiple diffractive optical elements, which are preferably Dammann gratings, or by refractive optical elements, which are preferably microlens arrays, the individual rays being launched essentially parallel to each other on grating structures (c) at the resonance angle for in-coupling into layer (a).

For certain applications, it is preferred, that two or more light sources of similar or different emission wavelength are used as excitation light sources.

For such applications, where two or more different excitation wavelengths shall be irradiated, an embodiment of the optical system is preferred where the excitation light from two or more light sources is launched simultaneously or sequentially from different directions on a grating structure (c) and in-coupled by that structure into layer (a), the grating structure comprising a superposition of grating structures of different periodicity.

It is preferred to use at least one laterally resolving detector for signal detection, for example, from the group formed by CCD cameras, CCD chips, photodiode arrays, avalanche diode arrays, multichannel plates and multichannel photomultipliers.

According to this invention, the optical system comprises such embodiments where optical components of the group formed by lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation and/or luminescence light are located between the one or more excitation light sources and the optical structure according to the invention and/or between the optical structure and the one or more detectors.

It is also possible, that the excitation light is launched in pulses with a duration between 1 fsec and 10 min, and, optionally, the emission light from the measurement areas is measured time-resolved. Thereby, the measurement of the emission light from the measurement areas can be performed correlated with the pulsed irradiation of the excitation light, upon use of detectors with an adequate temporal resolution. Whereas typically femto-second lasers with a high pulse repetition rate have been used for two-photon fluorescence excitation in arrangements known in the state-of-the-art, it is characteristic for the optical system according to the invention, with an optical structure according to the invention, that also lasers with a longer pulse duration (e.g. pico-second or even nano-second lasers), optionally also at a lower repetition rate, can be used as excitation light sources for multi-photon luminescence excitation (preferably for two-photon luminescence excitation).

When using very short-pulsed lasers, the dependence of the spectral bandwidth of the excitation pulse from the pulse length (as a consequence of the uncertainty relationship) has to be taken into account, in order to maximize the efficiency of in-coupling the excitation light from such a laser into an optical structure according to the invention. For example, a 100 fs-laser can have a bandwidth of the order of 5-15 nm. This means, with respect to an achievable efficiency of incoupling into a waveguide structure by means of a grating structure (c), that—in a case of shallow gratings, for example, with a depth<10 nm—the resonance condition for in-coupling is satisfied only for a small part of the irradiated spectrum at a certain adjustment angle, and thus the in-coupling efficiency is low. Using deeper gratings, the sharpness of the resonance condition can be reduced, with respect to both the angular and the spectral acceptance. This means as a general rule, that this relationship has to be taken into account for an optimization of the grating parameters when using laser pulses shorter than 1-10 psec (dependent also on the other system parameters). As a tendency, larger grating depths are required for in-coupling of shorter laser pulses.

Characteristic for further preferred embodiments of an optical system according to the invention is that, for referencing purposes, light signals of the group formed by excitation light at the location of the light sources, after expansion of the excitation light, or after its dividing into individual beams, scattered light at the excitation wavelength from the location of the one or more laterally separated measurement areas, and light of the excitation wavelength out-coupled by the grating structure (c) besides the measurement areas are measured. Thereby, it is especially advantageous if the measurement areas for determination of the emission light and of the reference signal are identical.

Launching of the excitation light and detection of the emission light from one or more measurement areas can be performed sequentially for one or more measurement areas. Thereby, sequential excitation and detection can be performed by means of movable optical components of the group formed by mirrors, deviating prisms, and dichroic mirrors.

Part of the invention is also such an optical system where sequential excitation and detection is performed using an essentially focus and angle preserving scanner. It is also possible that the optical structure is moved between steps of sequential excitation and detection.

A further subject of the invention is an analytical system for the determination of one or more analytes, by multi-photon excitation of the analyte, its binding partners, or of the molecules of a sample matrix surrounding the analyte molecules, in at least one sample on one or more measurement areas on an optical structure comprising an optical waveguide. The analytical system comprises

an optical structure according to the invention and to any of the described embodiments and

an optical system according to the invention and to any of the embodiments described above.

Again, said optical waveguide is preferably provided as an optical thin-film waveguide.

A special embodiment of such an analytical system according to the invention is characterized in that it is a measurement system for mass spectrometry, preferably MALDI/TOF-MS (matrix-assisted laser desorption time-of-flight mass spectrometry), and that said optical structure is a sample carrier for mass spectrometry, the analyte molecules to be determined, preferably molecules of higher molecular weight, especially natural and artificial (synthetic) polymers respectively biological molecules, such as proteins, polypeptides and nucleic acids, being embedded in a matrix of photo-reactive molecules, from which they can be dissociated respectively desorbed by multi-photon excitation of said photo-reactive molecules.

Characteristic for a special embodiment is that a photo-polymerization is initiated by the multiphoton excitation of said photo-reactive molecules located on layer (a) or within a distance of less than 200 nm from layer (a).

Characteristic for another variant is, that a photo-dissociation, i.e., the breakage of a molecule or molecular complex existing before the step of multi-photon excitation, is initiated by the multi-photon excitation of said photo-reactive molecules located on layer (a) or within a distance of less than 200 nm from layer (a).

Preferred is an analytical system for determination of one or more analytes in at least one sample on one or more measurement areas of an optical structure, comprising an optical waveguide (preferably provided as a thin-film waveguide), by luminescence detection, upon multi-photon excitation of the analyte or one of its binding partners, the analytical system comprising

an optical structure according to the invention

an optical system according to the invention and

supply means for bringing the one or more samples into contact with the measurement areas on the optical structure.

Thereby, it is preferred that the analytical system additionally comprises one or more sample compartments, which are open towards the optical structure at least in the region of the one or more measurement areas, the sample compartments preferably having a volume of 0.1 nl-100 μl each.

As a possible embodiment, the sample compartments are closed at the side facing away from the optically transparent layer (a), except for inlet and outlet openings for the supply or removal of samples and of optional additional reagents, and the supply or removal of the samples and of optional additional reagents is performed in a closed through-flow system, wherein, in case of liquid supply to several measurement areas or segments with common inlet and outlet openings, these openings are preferably addressed row by row or column by column.

Characteristic for another possible embodiment is that the sample compartments are provided with openings for the locally addressed supply or removal of the samples or other reagents at the side facing away from the optically transparent layer (a).

Especially suited for screening applications, for example, for the selection of compounds capable of binding to a so-called “target” compound and for the enrichment of these compounds in consecutive process steps, is an analytical system for the determination of one or more analytes by luminescence detection, upon luminescence excitation of the analyte or one of its binding partners in at least one sample on one or more measurement areas on an optical structure comprising an optical waveguide (preferably provided as a thin-film waveguide), with

an optical structure according to the invention

an optical system according to the invention

supply means for bringing the one or more samples into contact with the measurement areas on the optical structure

one or more sample compartments for receiving the one or more samples and optionally additional reagents and

means for removing the liquid contained in the sample compartments,

wherein, after detection of the binding of the one or more analytes in one or more measurement areas, the molecular complex formed between said analyte and the respective immobilized recognition element and, optionally, additional bindung partners, can be disrupted by photodissociation after multi-photon excitation or be desorbed from the optical structure, and whererin said molecular complex as a whole or in fragmented form can be subjected to a further analytical or preparative treatment, after elution from the respective sample compartment.

Thereby, such an embodiment of an analytical system according to the invention is preferred which allows for a separation of different molecular complexes or of fragments of molecular complexes, formed with the analytes detected in one or more samples on said optical structure, according to the absorption cross section of these molecular complexes for photo-dissociation by multi-photon excitation.

A further subject of the invention is a method for multi-photon excitation, comprising the use of an optical structure according to the invention and/or of an optical system according to the invention and/or of an analytical system according to the invention, wherein the intensity of an excitation light in-coupled into layer (a) and guided in layer (a) is high enough within layer (a) and on layer (a) that molecules located on the surface of layer (a) or within a distance of less than 200 nm from layer (a) can be excited by multi-photon excitation.

Characteristic for one group of embodiments of the method according to the invention is that molecules located on the surface of layer (a) or at a distance of less than 200 nm from layer (a) of the optical structure are photo-reactive and can be excited to a chemical reaction by multiphoton excitation.

Thereby, as one variant, molecules located on the surface of layer (a) or at a distance of less than 200 nm from layer (a) of the optical structure can be excited to bind to other molecules by multiphoton excitation. Characteristic for a special embodiment is that molecules located on the surface of layer (a) or at a distance of less than 200 nm from layer (a) of the optical structure can be excited to a photo-polymerization by multi-photon excitation.

Characteristic for another variant of the method is, that a photodissociation, i.e., a breakage of a molecule or molecular complex existing until multi-photon excitation on layer (a) or within a distance of less than 200 nm from layer (a) polymerization is initiated by the multi-photon excitation of said photo-reactive molecules located on layer (a) or within a distance of less than 200 nm.

Characteristic for a special embodiment of the method according to the invention is that said analytical system is a measurement system for mass spectrometry, preferably MALDI/TOF-MS (matrix-assisted laser desorption time-of-flight mass spectrometry), and that said optical structure is a sample carrier for mass spectrometry, the analyte molecules to be detected, preferably molecules of higher molecular weight, especially natural and artificial (synthetic) polymers respectively biological molecules, such as proteins, polypeptides and nucleic acids, being embedded in a matrix of photo-reactive molecules, from where they can be dissociated respectively desorbed upon multi-photon excitation of said photo-reactive molecules.

A preferred embodiment is a method for luminescence excitation comprising the use of an optical structure according to the invention and/or of an optical system according to the invention and/or of an analytical system according to the invention, wherein the intensity of an excitation light in-coupled into layer (a) and guided in layer (a) is high enough on layer (a) and within layer (a) that molecules located on the surface of layer (a) or within a distance of less than 200 nm from layer (a) are excited to luminescence by multi-photon excitation.

Specially preferred is a method for the detection of one or more analytes by luminescence detection in one or more samples on one or more measurement areas of an optical structure according to the invention and any of the described embodiments, for the determination of one or more luminescences from a measurement area or from an array of at least two or more laterally separated measurement areas (d) or of at least two or more laterally separated segments (d′) comprising several measurement areas on said optical structure, wherein the intensity of an excitation light in-coupled into layer (a) and guided in layer (a) is high enough on layer (a) and within layer (a), that molecules located on the surface of layer (a) or within a distance of less than 200 nm from layer (a) are excited to luminescence by multi-photo excitation.

In the method according to the invention, the in-coupling of excitation light into layer (a) can be performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

It is preferred that in-coupling of the excitation light into layer (a) is performed by means of a grating structure modulated in layer (a).

Preferably the optical structure is a planar thin-film waveguide structure.

Specially preferred is a method comprising the use of an optical structure, comprising a planar thin-film waveguide with a layer (a), optically transparent at least at an excitation wavelength, on a layer (b) with lower refractive index than layer (a), also optically transparent at least at said excitation wavelength, and with at least one grating structure (c) modulated in layer (a), wherein the intensity of an excitation light launched at the resonance angle for in-coupling into layer (a) is sufficiently high on layer (a) and within layer (a) at least in the region of the grating structure (c) that molecules located on the surface of layer (a) or within a distance of less than 200 nm from layer (a) are excited by multi-photon excitation.

It is preferred that the multi-photon excitation is a two-photon excitation.

Advantageous are embodiments of the method according to the invention, wherein molecules located on the surface of layer (a) of the optical structure or within a distance of less than 200 nm from layer (a) can be excited by multi-photon excitation along a linear path, i.e., simultaneously along the excitation light guided in layer (a).

Of special advantage are such embodiments wherein multi-photon excitation of molecules located on the surface of layer (a) or within a distance of less than 200 nm from layer (a) is enabled along a linear path along a distance of at least 5 mm, starting from the position of the in-coupling of the excitation light into layer (a).

It is also preferred that, upon irradiation of an expanded excitation light, molecules located on the surface of layer (a) or within a distance of less than 200 nm from layer (a) can be excited simultaneously on extended areas along the excitation light guided in layer (a) by multi-photon excitation. In case of in-coupling of light into layer (a) by means of a grating structure (c) modulated in layer (a), the excitation light bundle is again preferably expanded in parallel to the grating lines.

Of special advantage are also such embodiment of the method according to the invention which enable simultaneous multi-photon excitation of molecules located on the surface of layer (a) or within a distance of less than 200 nm from layer (a) on an area of at least 1 mm², more preferred on an area of at least 10 mm², still more preferred on an area of at least 1 cm².

It can be advantageous for different embodiments of the method according to the invention if the optical structure comprises continuous, unmodulated regions of layer (a), which are preferably arranged in direction of propagation of the excitation light in-coupled by a grating structure (c) and guided in layer (a). It can be of special advantage if the optical structure comprises a multitude of grating structures (c) with identical or different periods, optionally adjacent thereto with continuous, unmodulated regions of layer (a) on a common, continuous substrate. Thereby, in a preferred embodiment of the method, the optical system is designed in such a way that a luminescence generated on or in the near-field of layer (a) of the optical structure by multi-photon absorption, is coupled at least partially into layer (a) and is propagated to adjacent regions on said optical structure by guiding in layer (a).

For the methods of luminescence detection described above, (1) the isotropically luminescence or (2) luminescence that has been in-coupled into layer (a) and out-coupled by grating structures (c) or luminescences of both portions (1) and (2) simultaneously can be measured.

For the generation of luminescence or fluorescence, in the method according to the invention, a luminescence or fluorescence label can be used, which can be excited at a wavelength between 200 nm and 1100 nm. The luminescence or fluorescence labels can be conventional luminescence or fluorescence dyes or also luminescent or fluorescent nanoparticles, based on semiconductors (W. C. W. Chan and S. Nie, “Quantum dot bioconjugates for ultrasensitive nonisotopic detection”, Science 281 (1998) 2016-2018). Of course, those luminescence labels are best suited, which have an especially large multi-photon absorption cross section, in case of the preferred two-photon excitation an specially large two-photon absorption cross section, at the applied excitation wavelength, and which simultaneously show a photo-stability as high as possible.

It is preferred, that the luminescence label is excited by two-photon absorption. It is especially preferred, that said luminescence label is excited to an ultraviolet or blue luminescence by two-photon absorption of an excitation light in the visible or near infrared.

The luminescence label can be bound to the analyte or, in a competitive assay, to an analyte analogue or, in a multi-step assay, to one of the binding partners of the immobilized biological, biochemical or synthetic recognition elements, or to the biological, biochemical or synthetic recognition elements.

Additionally, a second or more luminescence labels of similar or different excitation wavelength as the first luminescence label and similar or different emission wavelength can be used. Thereby, it can be advantageous if the second or more luminescence labels can be excited at the same wavelength as the first luminescence label, but emit at other wavelengths.

For other applications, it can be advantageous if the excitation and emission spectra of the applied luminescent dyes do not or only partially overlap.

In the method according to the invention, it can be further advantageous if charge or optical energy transfer from a first luminescent dye acting as a donor to a second luminescent dye acting as an acceptor is used for the detection of the analyte.

A special embodiment of the method for determination of one or more analytes by luminescence detection, according to the invention, is based on the ability to excite the native fluorescence (“autofluorescence”) of biomolecules capable of fluorescence, such as proteins like tryptophane, tyrosin or phenylaniline with amino acids capable of fluorescence, which are located on the surface of layer (a) or at a distance of less than 200 nm from layer (a), by multi-photon absorption (preferably by two-photon absorption). Within this group tryptophane, with a molar extinction coefficient of about 5600 (1 mol⁻¹ cm⁻¹) at 280 nm and a quantum yield of 20%, of the emission around 360 nm, is preferred. Therefore, an excitation of the tryptophane fluorescence is typically not possible by a classical one-photon absorption process in the evanescent field of a high-refractive waveguide, as excitation light of such short wavelength is not guided over significant distance in the waveguide, but absorbed or scattered out. It is often also not possible to deliver such short-wavelength excitation light to the waveguide, for example, if the excitation light first has to pass through a material absorbing at this wavelength (like, for example, most plastics). Following the method according to the invention, however, it is possible to apply excitation light of adequate longer wavelength for a two-photon absorption process, which is guided in the waveguiding layer (a) over longer distances, and thus excite the short-wavelength fluorescence. As a special advantage, this variant of the method does not require the chemical association of the analyte or of one of its binding partners in a determination method with a luminescence label. Instead, the determination can be based directly on the detection of biological compounds capable of luminescence, which are occurring as a natural part of these compounds, or which are inserted into the analyte or into one of its binding partners in a biological production process.

For this special embodiment of a method according to the invention, there are again many possible sub-variants. For example, the biological or biochemical or synthetic recognition elements immobilized for analyte detection can be selected in such a way that they show (under the applied experimental conditions) no native luminescence or luminescence as low as possible, upon multi-photon excitation. Thus it is possible to minimize the background signal in the step of analyte detection upon luminescence excitation by multi-photon absorption of the analyte itself or of one of the binding partners applied in the determination method. Another advantageous embodiment is based on the determination of the immobilization density of the immobilized biological, biochemical or synthetic recognition elements in the measurement areas by means of their native luminescence (native fluorescence or autofluorescence) excited by multi-photon absorption. Thus, it is possible to correct and/or normalize the luminescence signal from the analyte or from one of its binding partners, excited during the analyte detection step (by multi-photon-absorption or by one-photon absorption), with respect to the number and density of available binding sites.

Especially, under the condition of adequate absorption spectra of the analytes and/or of their binding partners and of the immobilized recognition elements, for one-photon respectively multi-photon absorption, one and the same laser can be applied for (simultaneous or sequential) one-photon and multi-photon excitation luminescence, wherein, in case of such a sequential excitation, the preferred sequence can vary dependent on the specific application.

For a very high energy density on the surface of layer (a) and using luminophores of adequate absorption cross sections, it can be imagined that a luminescence excitation can be performed simultaneously at three different wavelengths, for example with a laser of 1064 nm emission wavelength excitation of an NIR dye by one-photon absorption, excitation of a dye in the visible (at about 532 nm) by two-photon absorption, and of a UV dye by three-photon absorption (at around 355 nm). The corresponding wavelengths, when using a laser emitting at 780 nm, would be 390 nm for the two-photon absorption and 260 nm for the three-photon absorption.

Thus, the method of multi-photon excitation, according to the invention, can be combined with the simultaneous or sequential luminescence detection of the emission from molecules capable of luminescence, which are excited by a process of one-photon absorption at the irradiated wavelength.

Additionally, it can be advantageous if the measurements of the one or more luminescences and/or determinations of light signals at the excitation wavelengths are performed polarization-selective. Additionally, the method provides the possibility to measure the one or more luminescence at a polarization that is different from the one of the excitation light.

A further subject of the invention is an embodiment of the method according to the invention, using an analytical system for the determination of one or more analytes by luminescence detection, upon luminescence excitation of the analyte or of one of its binding partners (after one-photon or multi-photon excitation) in at least one sample on one or more measurement areas on an optical structure comprising an optical waveguide (preferably provided as a thin-film waveguide), with

an optical structure according to the invention

an optical system according to the invention

supply means for bringing the one or more samples into contact with the measurement areas on the optical structure

one or more sample compartments for receiving the one or more samples and optionally additional reagents and

means for removing the liquid contained in the sample compartments,

wherein, after detection of the binding of the one or more analytes in one or more measurement areas, the molecular complex formed between said analyte and the respective immobilized recognition element and, optionally, additional bindung partners, can be disrupted by photo-dissociation after multi-photon excitation or be desorbed from the optical structure, and whererin said molecular complex as a whole or in fragmented form can be subjected to a further analytical or preparative treatment, after elution from the respective sample compartment.

Characteristic for a special variant of the method according to the invention is that molecules located on the surface of layer (a) or at distance of less than 200 nm from layer (a) are trapped within this distance due to the large amplification of an irradiated excitation light on layer (a) and within layer (a), as the high surface-confined excitation light intensity and its increasing gradient in direction towards the surface exposes these molecules to the effect of “optical tweezers”.

The method according to the invention and any of the embodiments described above allows for the simultaneous and/or sequential, quantitative and/or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

The samples to be examined can be naturally occurring body fluids, such as blood, serum, plasma, lymph or urine, or egg yolk.

A sample to be examined can also be an optically turbid liquid or surface water, soil extract, plant extract, or a bio- or process broth.

The samples to be examined can also be taken from biological tissue pieces.

A further subject of the invention is the use of an optical structure according to the invention and/or of an optical system according to the invention and/or of an analytical system according to the invention and/or of a method according to the invention, and each according to any of the embodiments described above, for quantitative and/or qualitative analyses for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for the determination of pathogens, nocuous agents and germs, especially of salmonella, prions and bacteria, in food and environmental analytics.

A further subject of the invention is the use of an optical structure according to the invention and/or of an optical system according to the invention and/or of a method according to the invention in nonlinear optics or telecommunication or communication techniques.

Quite in general, an optical structure according to the invention and/or an optical system according to the invention and/or an analytical system according to the invention and/or of a method according to the invention are suitable for surface-confined investigations which require the application of very high excitation light intensities and/or excitation durations, such as studies of photostabilities of materials, photocatalytic processes, etc.

By means of the following example, the invention shall be explained in more detail, without the intention to limit the generality of the invention by the described specific embodiments.

It is shown on

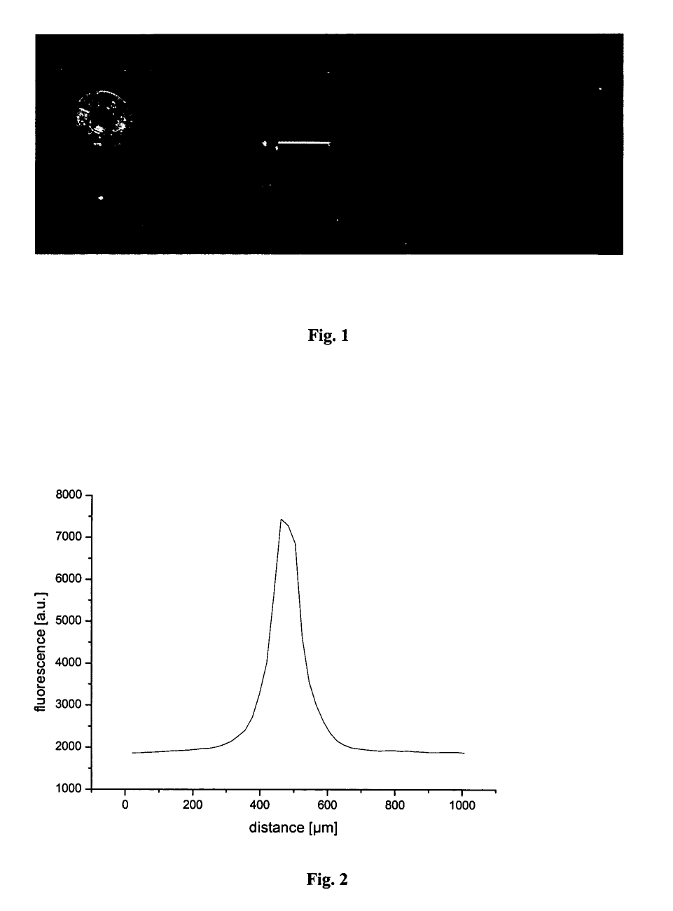

FIG. 1 a CCD-camera image of a fluorescence that is visible by naked eye and generated after two-photon excitation by means of a waveguide structure according to the invention.

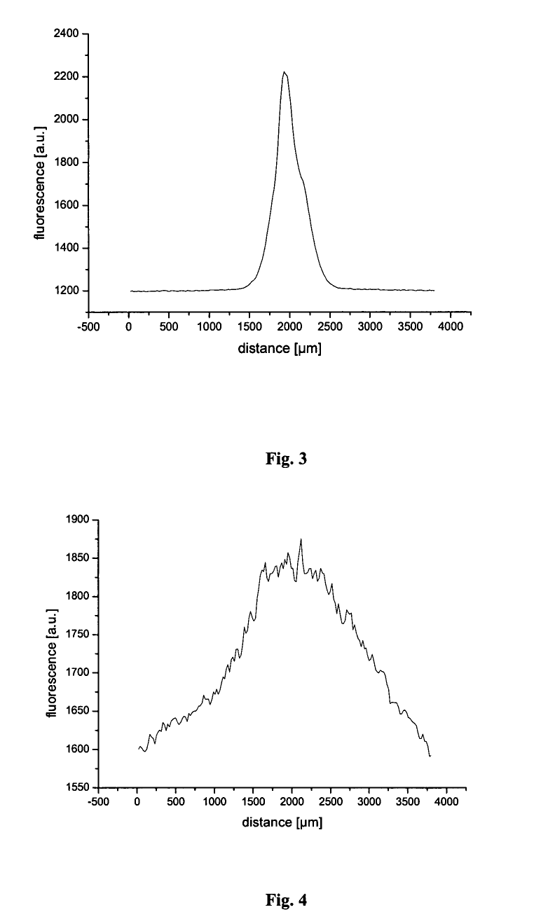

FIG. 2 and FIG. 3 cross-sectional profiles of the fluorescence generated by two-photon excitation, when the excitation is performed using excitation light beams that are collimated to a different extent.

FIG. 4 the cross-sectional profile of the fluorescence generated by two-photon fluorescence, after excitation using an excitation light beam that is expanded in parallel to the grating lines of the optical structure.

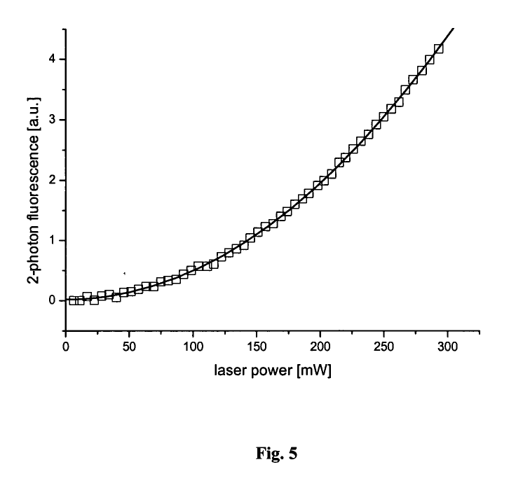

FIG. 5 the quadratic dependence of the measured fluorescence intensity on the excitation light intensity.

### EXAMPLE 1

1. Optical Structure for Two-Photon Excitation of a Luminescence

The optical structure consists of a glass substrate (AF45 glass as optical layer (b), n=1.496 at 800 nm) with a 150 nm thin layer (a) of tantalum pentoxide (waveguiding layer (a), n=2.092 at 800 nm). Coupling gratings in the form of relief gratings generated in layer (a) at a spacing of 9 mm (grating period 360 nm, grating depth 12 nm) are used for the in- and out-coupling of light into and out of, respectively, layer (a). Under these conditions, the in-coupling angle, in a direction from the glass substrate (optical layer (b), n=1.496 at 810 nm) towards the waveguiding layer (a) is −20.4°; and the external launching angle onto layer (a) (measured against the normal of the optical structure) amounts to −31.4°.

For generation and demonstration of the suitability of this optical structure for a two-photon excitation, a drop of 0.5 μl of a solution of rhodamine in ethanol (15.9 μM rhodamine B in ethanol) is deposited between two grating structures on layer (a), such that the rhodamine molecules, as examples of molecules capable of luminescence, remain on layer (a) after evaporation of the ethanol.

2. Optical System for Two-Photon Excitation, Process of Measurement for Two-Photon Excitation and Results

A pulsed titanium sapphire laser emitting around 800 nm (pulse length: 100 fs; repetition rate: 80 MHz, applied average power: up to 0.6 W, spectral pulse width: 8 nm) is used as the excitation light source. The intensity of the excitation light emitted by the laser can be regulated continuously between 0% and 100% of the original power using an electro-optical modulator; it can also be ramped up or down continuously in this range under computer control.

Lenses can be inserted into the excitation light path after the electro-optical modulator (in a direction towards the waveguide structure), in order to generate parallel launched excitation light bundles of a desired geometry on the in-coupling grating (c) of the optical structure. The launched excitation light is directed towards the in-coupling grating (c) of the optical structure using a mirror mounted on an adjustment component allowing for translation in x-, y-, and z-directions (in parallel and perpendicular to the grating lines) and for rotation (with a rotation axis that is identical with the grating lines of the in-coupling grating).

At an irradiated average power of 0.4 W, a collimated beam is first directed onto the in-coupling grating at the resonance angle for in-coupling. Therefore, the beam is slightly focused with a lens (f=12.7 cm), the in-coupling grating (plane of the optical structure) being located in the beam waste, so that the excitation light arrives at the in-coupling grating as a planar wave. Surprisingly, such a strong two-photon fluorescence is excited in the region of the immobilized luminescence dye along the mode guided in the optical structure, that it can be observed even by naked eye under room light (FIG. 1, taken without filter). The image section shows the holder with the optical structure mounted inside. The bright light spot on the left indicates the position of in-coupling of the excitation light on the in-coupling grating. As the picture has been taken without any filter, the intensity of the excitation light scattered at the grating is strong enough that it is recorded by the camera, in spite of the camera's decreasing sensitivity at long wavelengths. The in-coupled mode (at a wavelength of 800 nm) is propagated from left to right in the image plane. Before reaching the region where the rhodamine dye is immobilized, the guided mode is invisible. Then, in further direction of mode propagation towards the right, the fluorescence of the rhodamine dye generated by two-photon excitation is clearly visible. The observed light trace corresponds to a length of 8 mm until the next grating structure where the guided excitation light is out-coupled again. Along the whole distance, a significant attenuation of the guided light, respectively of the excited two-photon fluorescence, cannot be observed.

FIG. 2 shows in a cross-sectional view, in parallel to the grating lines, the profile of the excited two-photon fluorescence, imaged using an IR-blocking filter (BG 39) in front of a CCD camera as the detector. The excitation beam profile was adjusted to a theoretical width of about 100 μm on the grating, which is in good agreement with the measured half-width of the fluorescence trace. In this example, fluorescence has thus been generated by two-photon excitation along a linear trace over a distance of 8 mm (on an area of about 2 mm², taking the base width of the fluorescence profile). It has to be noted that the propagation length of the guided excitation light and, thus, the excitation length for two-photon excitation, is only limited by the out-coupling grating.

FIG. 3 shows a corresponding fluorescence profile for a directly irradiated laser beam, without further beam-forming lenses. In this case, the half-width of the fluorescence profile is about 360 μm, and the base width is about 800 μm, corresponding to fluorescence excited by two-photon excitation on a total area of about 6 mm² (along the mode propagation length of 8 mm). In a further step, the laser beam is then expanded in parallel to the grating lines with a cylindrical lens (f=40 mm). From the corresponding fluorescence profile (FIG. 4), a half-width of about 1.7 mm and a base width of about 3 mm are determined, corresponding to fluorescence excited by two-photon excitation on a total area of more than 20 mm².

An important criterion for the undoubtedly identification of an excited fluorescence as being caused by two-photon excitation is the quadratic dependence of its intensity on the irradiated excitation intensity. For this purpose, a Si photodiode, connected to a lock-in amplifier (chopper frequency: 2 kHz) is used as a detector, instead of the CCD-camera. The isotropically emitted fluorescence, excited by two-photon excitation in the evanescent field of the waveguide structure, is focused onto said photodiode by a lens, again with an IR-blocking filter (BG 39) positioned in front of the photodiode. By means of the computer-controlled electro-optical modulator, the excitation intensity irradiated onto the optical structure is increased from 0 mW up to close to 300 mW (irradiated average power) in increments of 6 mW, and the generated fluorescence intensity is simultaneously measured. FIG. 5 shows the measured fluorescence intensities and—as a straight line—a fit of the measured intensities according to the equation y•=•ax² (with y corresponding to the fluorescence intensity, x corresponding to the excitation intensity, a corresponding to a fitting parameter). Surprisingly, a perfect quadratic dependence of the measured fluorescence intensity on the excitation intensity is found, without any offset, which would correspond to an additional background signal. Thus, it is demonstrated in this example that the measured fluorescence has to be attributed undoubtedly to two-photon excitation, and that this two-photon fluorescence can be excited—under these experimental conditions—without any background signals.

### EXAMPLE 2

### Optical system for two-photon excitation

A high-power laser diode with an emission wavelength of 810 nm (fiber-coupled; 10 W) is used as an excitation light source. By means of beam-shaping optics located behind the fiber (in direction of light propagation), a parallel excitation light bundle of desired geometry is generated and irradiated onto the grating (grating period 360 nm, grating depth 12 nm) at the coupling angle for in-coupling into the waveguiding layer (a) of the optical structure. The in-coupling angle in the glass substrate (optical layer (b), n=1.496 at 810 nm) is −21.7°; and the external launching angle is −34.1°. The waveguiding layer (a) is 150 nm tantalum pentoxide (n=2.09 at 810 nm). Using these parameters, a fraction of 24% can be coupled into layer (a), and the excitation light intensity at the surface of layer (a) is sufficient for a two-photon excitation.

1. An optical structure comprising: an optical waveguide with a waveguiding layer (a), optically transparent at least at an excitation wavelength, wherein the intensity of an excitation light in-coupled into layer (a) and guided in layer (a) is high enough within layer (a) and on layer (a), that molecules or molecular groups located on the surface of layer (a) or within a distance of less than 200 nm can be excited by multi-photon excitation.

2. An optical structure according to claim 1, wherein the optical waveguide is an optical thin-film waveguide, with a waveguiding layer (a), optically transparent layer at least at an excitation wavelength, on a layer (b) with lower refractive index than layer (a), also optically transparent at least at said excitation wavelength.

3. An optical structure according to any of claims 1-2, wherein the molecules located on the surface of layer (a) or within a distance of less than 200 nm and excited by multi-photon excitation are photo-reactive molecules or molecular groups, i.e., which are chemically reactive after excitation by light.

4. An optical structure according to claim 3, wherein a photopolymerization is initiated by the multi-photon excitation of said photo-reactive molecules located on layer (a) or within a distance of less than 200 nm.

5. An optical structure according to claim 3, wherein a photodissociation, i.e., a breakage of a molecule or molecular complex existing until multi-photon excitation on layer (a) or within a distance of less than 200 nm from layer (a) is initiated by the multi-photon excitation of said photo-reactive molecules located on layer (a) or within a distance of less than 200 nm.

6. An optical structure according to claim 5, wherein said photo-reactive molecules are part of a molecular matrix for embedding molecules of higher molecular weight, especially for embedding natural and artificial (synthetic) polymers respectively biological molecules, such as proteins, polypeptides, and nucleic acids.

7. An optical structure according to claim 6, wherein said structure is provided as a sample carrier for mass spectrometry, preferably for MALDI/TOF-MS (matrix-assisted laser desorption/ionization time-of-flight mass spectrometry).

8. An optical structure according to any of claims 1-7, comprising an optical thin-film waveguide with a waveguiding layer (a), optically transparent at least at an excitation wavelength, on a layer (b) of lower refractive index than layer (a), also optically transparent at least at said excitation wavelength, wherein the intensity of an excitation light in-coupled into layer (a) and guided in layer (a) is high enough on layer (a) and within layer (a) that molecules located on the surface of layer (a) or within a distance of less than 200 nm from layer (a) are excited to luminescence by multi-photo excitation.

9. An optical structure according to any of claims 1-8, wherein in-coupling of excitation light into layer (a) is performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

10. An optical structure according to claim 9, wherein in-coupling of the excitation light into layer (a) is performed by means of a grating structure modulated in layer (a).

11. An optical structure according to any of claims 1-10, wherein said structure is a planar thin-film waveguide structure.

12. An optical structure according to claim 11, comprising a planar thin-film waveguide, with a layer (a), optically transparent at least at an excitation wavelength, on a layer (b) with lower refractive index than layer (a), also optically transparent at least at said excitation wavelength, and with at least one grating structure (c) modulated in layer (a), wherein the intensity of an excitation light launched at the resonance angle for in-coupling into layer (a) is sufficiently high on layer (a) and within layer (a) at least in the region of the grating structure (c), that molecules located on the surface of layer (a) or within a distance of less than 200 nm from layer (a) are excited by multi-photon excitation.

13. An optical structure according to any of claims 1-12, wherein the multi-photon excitation is a two-photon excitation.

14. An optical structure according to any of claims 1-13, wherein it is operable to excite molecules located on the surface of layer (a) or within a distance of less than 200 nm from layer (a) by multi-photon excitation along a linear path, i.e., simultaneously along the excitation light guided in layer (a).

15. An optical structure according to claim 14, wherein it is operable for multi-photon excitation of molecules located on the surface of layer (a) or within a distance of less than 200 nm from layer (a) along a linear path along a distance of at least 5 mm, starting from the position of the in-coupling of the excitation light into layer (a).

16. An optical structure according to any of claims 1-15, wherein it is operable, upon irradiation of an expanded excitation light, to excite molecules located on the surface of layer (a) or within a distance of less than 200 nm from layer (a) by multi-photon excitation simultaneously on extended areas along the excitation light guided in layer (a).

17. An optical structure according to any of claims 1-16, wherein it is operable for simultaneous multi-photon excitation of molecules located on the surface of layer (a) or within a distance of less than 200 nm from layer (a) on an area of at least 1 mm².

18. An optical structure according to any of claims 1-16, wherein it is operable for simultaneous multi-photon excitation of molecules located on the surface of layer (a) or within a distance of less than 200 nm from layer (a) on an area of at least 10 mm².

19. An optical structure according to any of claims 1-16, wherein it is operable for simultaneous multi-photon excitation of molecules located on the surface of layer (a) or within a distance of less than 200 nm from layer (a) on an area of at least 1 cm².

20. An optical structure according to any of claims 10-19, wherein said structure comprises continuous, unmodulated regions of layer (a), which are preferably arranged in direction of propagation of an excitation light in-coupled by a grating structure (c) and guided in layer (a).

21. An optical structure according to any of claims 10-20, wherein said structure comprises a multitude of grating structures (c) with identical or different periods, optionally adjacent thereto with continuous, unmodulated regions of layer (a) on a common, continuous substrate.

22. An optical structure according to any of claims 8-21, wherein a luminescence generated on or in the near-field of layer (a) by multi-photon absorption, is coupled at least partially into layer (a) and is propagated to adjacent regions on said optical structure by guiding in layer (a).

23. An optical structure according to any of claims 12-22, characterized in that said structure comprises a superposition of two or more grating structures of different periodicity, with grating lines arranged in parallel or non-parallel, preferably non-parallel, which structure is operable for the in-coupling of excitation light of different wavelengths, wherein, in case of two superimposed grating structures their grating lines are preferably arranged perpendicular to each other.

24. An optical structure according to any of claims 2-23, wherein a further optically transparent layer (b′) with lower refractive index than the one of layer (a) and with a thickness of 5 nm-10 000 nm, preferably of 10 nm-1000 nm, is located between layers (a) and (b) and in contact with layer (a).

25. An optical structure according to any of claims 10-22 or 24, wherein the grating structure (c) is a diffractive grating with a uniform period or a multidiffractive grating.

26. An optical structure according to any of claims 10-25, wherein the grating structure (c) is provided with a laterally varying periodicity, perpendicular or in parallel to the direction of propagation of the excitation light coupled into the optically transparent layer (a).

27. An optical structure according to any of claims 1-26, wherein the material of the optically transparent layer (a) comprises glass, quartz or a transparent plastic, for example from the group comprising polycarbonate, polyamide, polyimide, polymethyl methacrylate, polypropylene, polystyrene, polyethylene, polyacrylic acid, polyacrylic ester, poly phenylenesulfide, poly ethyleneterephtalate (PET) and polyurethane and their derivatives.

28. An optical structure according to any of claims 1-27, wherein the optically transparent layer (a) comprises a material of the group of TiO₂, ZnO, Nb₂O₅, Ta₂O₅, HfO₂, orZrO₂, especially preferred of TiO₂ or Nb₂O₅ or Ta₂O₅.

29. An optical structure according to any of claims 1-28, wherein the refractive index of the optically transparent layer (a) is larger than 1.8.

30. An optical structure according to any of claims 1-29, wherein the optically transparent layer (a) is self-supporting.

31. An optical structure according to any of claims 1-29, wherein the optically transparent layer (a) is a low-modal waveguide, i.e., it is operable to guide less than the first 10 modes of a given polarization of an irradiated excitation light.

32. An optical structure according to claim 31, wherein the optically transparent layer (a) is a low-modal waveguide, which is operapable to guide only 1-3 modes of a given polarization of an irradiated excitation light.

33. An optical structure according to any of claims 2-32, wherein the material of the optically transparent layer (b) comprises glass, quartz or a transparent thermoplastic or moldable plastic, for example from the group formed by polycarbonate, polyimide, polymethyl methacrylate, polypropylene, polystyrene, polyethylene, polyacrylic acid, polyacryl ester, poly phenylenesulfide, poly ethyleneterephtalate (PET) and polyurethane.

34. An optical structure according to any of claims 1-33, wherein the product of the thickness of layer (a) and of its refractive index is between one tenth and a whole, preferably between one tenth and two thirds, of the excitation wavelength of the excitation light to be coupled into layer (a).

35. An optical structure according to any of claims 10-34, wherein grating structures (c) modulated in layer (a) have a period of 200 nm-1000 nm and a modulation depth of 3 nm to 100 nm, preferably of 10 nm-30 nm.

36. An optical structure according to any of claims 10-35, wherein the ratio of the modulation depth of the grating to the thickness of the first optically transparent layer (a) is equal or smaller than 0.2.

37. An optical structure according to any of claims 10-36, wherein the grating structure (c) is a relief grating with a rectangular, triangular or semi-circular profile or a phase or volume grating with a periodic modulation of the refractive index in the essentially planar, optically transparent layer (a).

38. An optical structure according to any of claims 1-37, wherein optically or mechanically recognizable marks for simplifying adjustments in an optical system and/or for the connection to sample compartments as part of an analytical system are provided on said structure.

39. An optical structure according to any of claims 1-38, wherein an adhesion-promoting layer (f) is deposited on the optically transparent layer (a), for immobilization of biological or biochemical or synthetic recognition elements (e) for the determination of one or more analytes in a supplied sample, with a thickness of preferably less than 200 nm, most preferably of less than 20 nm, and wherein the adhesion-promoting layer (f) preferably comprises a compound from the group comprising silanes, epoxides, functionalized, charged or polar polymers, and “self-organized functionalized monolayers”.

40. An optical structure according to any of claims 1-39, wherein laterally separated measurement areas (d) are generated by laterally selective deposition of biological, biochemical or synthetic recognition elements on said optical structure, preferably by applying one or more methods of the group of methods comprising ink jet spotting, mechanical spotting, micro contact printing, fluidic contacting of the measurement areas with the biological, biochemical or synthetic recognition elements upon their supply in parallel or crossed micro channels, upon application of pressure differences or electric or electromagnetic potentials.

41. An optical structure according to any of claims 1-40, wherein components of the group formed by nucleic acids (e.g. DNA, RNA, oligonucleotides) and nucleic acid analogues (e.g. PNA), antibodies, aptamers, membrane-bound and isolated receptors, their ligands, antigens for antibodies, “histidin-tag components”, cavities generated by chemical synthesis, for hosting molecular imprints, natural or synthetic polymers etc., or whole cells or cell fragments are deposited as biological or biochemical or synthetic recognition elements, and wherein these recognition elements are deposited directly or by means of an adhesion-promoting layer according to claim 39 on the optical structure.

42. An optical structure according to any of claims 40-41, wherein compounds, that are “chemically neutral” towards the analyte, are deposited between the laterally separated measurement areas (d), preferably for example out of the groups formed by albumins, especially bovine serum albumin or human serum albumin, fragmented natural or synthetic DNA not hybridizing with polynucleotides to be analyzed, such as herring or salmon sperm, or also uncharged but hydrophilic polymers, such as poly ethyleneglycols or dextranes.

43. An optical structure according to any of claims 40-42, wherein two or more laterally separated measurement areas are combined to segments on the optical structure, and that preferably different segments are additionally separated from each other by a deposited rim supporting the fluidic sealing between adjacent areas and/or contributing to a reduction of the optical cross-talk between adjacent areas.

44. An optical structure according to any of claims 40-43, wherein up to 1,000,000 measurement areas are provided in a two-dimensional arrangement, and wherein a single measurement area occupies an area of 0.001 mm²-6 mm².

45. An optical system for multi-photon excitation, comprising at least one excitation light source and an optical structure according to any of claims 1-44, wherein the intensity of an excitation light in-coupled into layer (a) and guided in layer (a) is high enough within layer (a) and on layer (a), that molecules located on the surface of layer (a) or within a distance of less than 200 nm can be excited by multi-photon excitation.

46. An optical system for multi-photon excitation according to claim 45, wherein the intensity of an excitation light in-coupled into layer (a) and guided in layer (a) is high enough within layer (a) and on layer (a), that molecules located on the surface of layer (a) or within a distance of less than 200 nm can be excited to luminescence by multi-photon excitation.

47. An optical system according to any of claims 45-46, wherein in-coupling of excitation light into layer (a) is performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

48. An optical system according to claim 47, wherein in-coupling of the excitation light into layer (a) is performed by means of a grating structure modulated in layer (a).

49. An optical system according to any of claims 45-48, wherein said structure is a planar thin-film waveguide structure.

50. An optical system according to claim 49, comprising at least one excitation light source and an optical structure according to any of claims 10-44, wherein the intensity of an excitation light launched at the resonance angle for in-coupling into layer (a) on a grating structure (c) modulated in layer (a) is sufficiently high on layer (a) and within layer (a) at least in the region of the grating structure (c), that molecules located on the surface of layer (a) or within a distance of less than 200 nm from layer (a) are excited by multi-photon excitation.

51. An optical system according to any of claims 45-50, wherein the multi-photon excitation is a two-photon excitation.

52. An optical system according to any of claims 45-51, wherein it is operable to excite molecules located on the surface of layer (a) or within a distance of less than 200 nm from layer (a) by multi-photon excitation along a linear path, i.e., simultaneously along the excitation light guided in layer (a).

53. An optical system according to claim 52, wherein it is operable for multi-photon excitation of molecules located on the surface of layer (a) or within a distance of less than 200 nm from layer (a) along a linear path along a distance of at least 5 mm, starting from the position of the in-coupling of the excitation light into layer (a).

54. An optical system according to any of claims 45-53, wherein it is operable, upon irradiation of an expanded excitation light, to excite molecules located on the surface of layer (a) or within a distance of less than 200 nm from layer (a) by multi-photon excitation simultaneously on extended areas along the excitation light guided in layer (a).

55. An optical system according to any of claims 45-54, wherein it is operable for simultaneous multi-photon excitation of molecules located on the surface of layer (a) or within a distance of less than 200 nm from layer (a) on an area of at least 1 mm².

56. An optical system according to any of claims 46-54, wherein a luminescence generated on or in the near-field of layer (a) by multi-photon absorption is coupled at least partially into layer (a) and is propagated to adjacent regions on said optical structure by guiding in layer (a).

57. An optical system according to any of claims 45-56, wherein it comprises additionally at least one detector for the detection of one or more luminescences from the optical structure.

58. An optical system according to any of claims 48-57, wherein the excitation light emitted from the at least one excitation light source is essentially parallel and irradiated on a grating structure (c) modulated in the optically transparent layer (a) at the resonance angle for in-coupling into layer (a).

59. An optical system according to any of claims 48-58, wherein the excitation light from at least one light source is expanded to an essentially parallel ray bundle by expansion optics and irradiated onto a grating structure (c) of macroscopic area modulated in the optically transparent layer (a) at the resonance angle for in-coupling into layer (a).

60. An optical system according to any of claims 48-59, wherein the excitation light from the at least one light source is divided into a plurality of individual rays of as uniform as possible intensity by a diffractive optical element, or in case of multiple light sources, by multiple diffractive optical elements, which are preferably Dammann gratings, or by refractive optical elements, which are preferably microlens arrays, the individual rays being launched essentially parallel to each other on grating structures (c) at the resonance angle for in-coupling into layer (a).

61. An optical system according to any of claims 45-60, wherein two or more light sources of similar or different emission wavelength are used as excitation light sources.

62. An optical system according to claim 61 with an optical structure according to claim 23, wherein the excitation light from two or more light sources is launched simultaneously or sequentially from different directions on a grating structure (c) and in-coupled by that structure into layer (a), said grating structure comprising a superposition of grating structures of different periodicity.

63. An optical system according to any of claims 45-62, wherein at least one laterally resolving detector is used for signal detection, for example from the group formed by CCD cameras, CCD chips, photodiode arrays, avalanche diode arrays, multichannel plates and multichannel photomultipliers.

64. An optical system according to any of claims 45-63, wherein optical components of the group formed by lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation and/or luminescence light are located between the one or more excitation light sources and the optical structure according to any of claims 1-44 and/or between said optical structure and the one or more detectors.

65. An optical system according to any of claims 46-64, wherein the excitation light is launched in pulses with a duration between 1 fsec and 10 min, and wherein, optionally, the emission light from the measurement areas is measured time-resolved.

66. An optical system according to any of claims 46-65, wherein, for referencing purposes, light signals of the group formed by excitation light at the location of the light sources or after expansion of the excitation light or after its dividing into individual beams, scattered light at the excitation wavelength from the location of the one or more laterally separated measurement areas, and light of the excitation wavelength out-coupled by the grating structure (c) besides the measurement areas are measured.

67. An optical system according to any of claims 46-66, wherein the measurement areas for determination of the emission light and of the reference signal are identical.

68. An optical system according to any of claims 46-67, wherein launching of the excitation light and detection of the emission light from one or more measurement areas is performed sequentially for one or more measurement areas.

69. An optical system according to claim 68, wherein sequential excitation and detection is performed by means of movable optical components of the group formed by mirrors, deviating prisms, and dichroic mirrors.

70. An optical system according to claim 69, wherein sequential excitation and detection is performed using an essentially focus and angle preserving scanner.

71. An optical system according to any of claims 68-70, wherein the optical structure is moved between steps of sequential excitation and detection.

72. A method for multi-photon excitation, comprising the use of an optical structure according to any of claims 1-44 and/or of an optical system according to any of claims 45-71, wherein the intensity of an excitation light in-coupled into layer (a) and guided in layer (a) is high enough within layer (a) and on layer (a) that molecules located on the surface of layer (a) or within a distance of less than 200 nm from layer (a) can be excited by multi-photon excitation.

73. A method according claim 72, wherein molecules located on the surface of layer (a) or at a distance of less than 200 nm from layer (a) of the optical structure are photo-reactive and can be excited to a chemical reaction by multi-photon excitation.

74. A method according to claim 73, wherein molecules located on the surface of layer (a) or at a distance of less than 200 nm from layer (a) of the optical structure can be excited to bind to other molecules by multi-photon excitation.

75. A method according to claim 73, wherein molecules located on the surface of layer (a) or at a distance of less than 200 m from layer (a) of the optical structure can be excited to a photo-polymerization by multi-photon excitation.

76. A method according to claim 73, wherein a photodissociation, i.e., a breakage of a molecule or molecular complex existing until multi-photon excitation on layer (a) or within a distance of less than 200 nm from layer (a) polymerization is initiated by the multi-photon excitation of said photo-reactive molecules located on layer (a) or within a distance of less than 200 nm.

77. A method for luminescence excitation, comprising the use of an optical structure according to any of claims 1-44 and/or of an optical system according to any of claims 45-71, wherein the intensity of an excitation light in-coupled into layer (a) and guided in layer (a) is high enough on layer (a) and within layer (a) that molecules located on the surface of layer (a) or within a distance of less than 200 nm from layer (a) are excited to luminescence by multi-photon excitation.

78. A method for the detection of one or more analytes by luminescence detection, in one or more samples on one or more measurement areas of an optical structure according to any of claims 39-44, for the determination of one or more luminescences from a measurement area or from an array of at least two or more laterally separated measurement areas (d) or of at least two or more laterally separated segments comprising several measurement areas on said optical structure, wherein the intensity of an excitation light in-coupled into layer (a) and guided in layer (a) is high enough on layer (a) and within layer (a) that molecules located on the surface of layer (a) or within a distance of less than 200 nm from layer (a) are excited to luminescence by multi-photon excitation.

79. A method according to any of claims 72-78, wherein in-coupling of excitation light into layer (a) is performed using one or more optical in-coupling elements from the group formed by prism couplers, evanescent couplers based on joined optical waveguides with overlapping evanescent fields, front face couplers with focusing lenses, preferably cylindrical lenses located in front of the waveguiding layer, and grating couplers.

80. A method according to any of claims 72-79, wherein in-coupling of the excitation light into layer (a) is performed by means of a grating structure modulated in layer (a).

81. A method according to any of claims 72-80, wherein the optical structure is a planar thin-film waveguide structure.

82. A method according to claim 81, comprising the use of an optical structure comprising a planar thin-film waveguide, with a layer (a), optically transparent at least at an excitation wavelength, on a layer (b) with lower refractive index than layer (a), also optically transparent at least at said excitation wavelength, and with at least one grating structure (c) modulated in layer (a), wherein the intensity of an excitation light launched at the resonance angle for in-coupling into layer (a) is sufficiently high on layer (a) and within layer (a) at least in the region of the grating structure (c), that molecules located on the surface of layer (a) or within a distance of less than 200 nm from layer (a) are excited by multi-photon excitation.

83. A method according to any of claims 72-82, wherein the multi-photon excitation is a two-photon excitation.

84. A method according to any of claims 72-83, wherein molecules located on the surface of layer (a) of the optical structure or within a distance of less than 200 nm from layer (a) can be excited by multi-photon excitation along a linear path, i.e., simultaneously along the excitation light guided in layer (a).

85. A method according to claim 84, wherein it is operable for multi-photon excitation of molecules located on the surface of layer (a) or within a distance of less than 200 nm from layer (a) along a linear path along a distance of at least 5 mm, starting from the position of the in-coupling of the excitation light into layer (a).

86. A method according to any of claims 80-85, wherein it is operable, upon irradiation of an expanded excitation light, to excite molecules located on the surface of layer (a) or within a distance of less than 200 nm from layer (a) by multi-photon excitation simultaneously on extended areas along the excitation light guided in layer (a).

87. A method according to any of claims 72-86, wherein it is operable for simultaneous multi-photon excitation of molecules located on the surface of layer (a) or within a distance of less than 200 nm from layer (a) on an area of at least 1 mm².

88. A method according to any of claims 72-87, wherein it is operable for simultaneous multi-photon excitation of molecules located on the surface of layer (a) or within a distance of less than 200 nm from layer (a) on an area of at least 1 cm².

89. A method according to any of claims 80-88, wherein the optical structure comprises continuous, unmodulated regions of layer (a), which are preferably arranged in direction of propagation of an excitation light in-coupled by a grating structure (c) and guided in layer (a).

90. A method according to any of claims 80-89, wherein the optical structure comprises a multitude of grating structures (c) with identical or different periods, optionally adjacent thereto with continuous, unmodulated regions of layer (a) on a common, continuous substrate.

91. A method according to any of claims 80-90, wherein a luminescence generated on or in the near-field of layer (a) of the optical structure by multi-photon absorption is coupled at least partially into layer (a) and is propagated to adjacent regions on said optical structure by guiding in layer (a).

92. A method according to any of claims 77-91, wherein, for the generation of luminescence, a luminescence dye or luminescent nanoparticle is used as a luminescence label, which can be excited at a wavelength between 200 nm and 1100 nm.

93. A method according to claim 92, wherein said luminescence label is excited by two-photon absorption.

94. A method according to claim 93, wherein said luminescence label is excited to an ultraviolet or blue luminescence by two-photon absorption of an excitation light in the visible or near infrared.

95. A method according to any of claims 92-94, wherein the luminescence label is bound to the analyte or, in a competitive assay, to an analyte analogue or, in a multi-step assay, to one of the binding partners of the immobilized biological, biochemical or synthetic recognition elements, or to the biological, biochemical or synthetic recognition elements.

96. A method according to any of claims 92-95, wherein a second or more luminescence labels of similar or different excitation wavelength as the first luminescence label and similar or different emission wavelength are used.

97. A method according to any of claims 77-91, wherein the native fluorescence (“autofluorescence”) of biomolecules capable of fluorescence, e.g., from proteins with fluorescent amino acids, is excited by multi-photon excitation.

98. A method according to claim 97, wherein said amino acids capable of fluorescence are selected from the group formed by tryptophane, tyrosine, and phenylalanine.

99. A method according to any of claims 77-98, wherein the immobilization density of the immobilized biological, biochemical or synthetic recognition elements in the measurement areas is determined from their native luminescence (native fluorescence or autofluorescence) excited by multi-photon absorption.

100. A method according to any of claims 77-99, wherein the luminescence signal from the analyte or from one of its binding partners, excited during the analyte detection step (by multi-photon-absorption or by one-photon absorption), is corrected and/or normalized with respect to the number and density of available binding sites based on the measured native luminescence of the immobilized biological, biochemical or synthetic recognition elements excited by multi-photon absorption.

101. A method according to any of claims 77-100, wherein the measurements of the one or more luminescences and/or determinations of light signals at the excitation wavelengths are performed polarization-selective, wherein preferably the one or more luminescences are measured at a polarization that is different from the one of the excitation light.

102. A method according to any of claims 72-101, wherein molecules located on the surface of layer (a) or at distance of less than 200 nm from layer (a) are trapped within this distance, due to the large amplification of an irradiated excitation light on layer (a) and within layer (a), as the high surface-confined excitation light intensity and its increasing gradient in direction towards the surface exposes these molecules to the effect of an “optical tweezers”.

103. Method according to any of claims 72-102 for the simultaneous and/or sequential, quantitative and/or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

104. A method according to any of claims 72-103, wherein the samples to be examined are naturally occurring body fluids, such as blood, serum, plasma, lymph or urine, or egg yolk, optically turbid liquids, surface water, soil extracts, plant extracts or bio- or process broths, or are taken from biological tissue pieces.

105. The use of an optical structure according to any of claims 1-44 and/or of an optical system according to any of claims 45-71 and/or of a method according to any of claims 72-104 for quantitative and/or qualitative analyses for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for the determination of pathogens, nocuous agents and germs, especially of salmonella, prions and bacteria, in food and environmental analytics.

106. The use of an optical structure according to any of claims 1-44 and/or of an optical system according to any of claims 45-71 and/or of a method according to any of claims 72-104 for surface-confined investigations which require the application of very high excitation light intensities and/or excitation durations, such as studies of photostabilities of materials, photocatalytic processes etc.
